(19) United States
(12) Patent Application Publication
(10) Pub. No.: US 2022/0212752 A1
(43) Pub. Date: Jul. 7, 2022

(54) ELECTRIC BICYCLE

(71) Applicant: Ian W. Hunter, Lincoln, MA (US)

(72) Inventor: Ian W. Hunter, Lincoln, MA (US)

(21) Appl. No.: 17/594,864

(22) PCT Filed: May 1, 2020
(86) PCT No.: PCT/US2020/031133

§ 371 Date: Nov. 1, 2021

Related U.S. Application Data
(60) Provisional application No. 62/842,241, filed on May 2, 2019.

(51) Int. Cl. B62M 6/65; B62K 15/00; B62K 1/00

(52) U.S. Cl. CPC B62M 6/65; B62K 13/08; B62K 1/00; B62K 15/008

(57) ABSTRACT

An electric powered bicycle includes front and rear wheels (102, 104) that swivel relative to a midframe (106). The midframe (106) includes a pedal driven generator-motor (108), and each wheel (102, 104) includes a motor-generator. The wheels (102, 104) may swivel to opposite sides of the midframe (106) about 180° to move into a collapsed configuration. Swivel may be on single axis joints (162, 168) with tilted swivel axes. In the collapsed configuration, the bicycle is suitable to be carried and stored and may also be utilized in a unicycle/exercycle configuration. By swiveling the wheels (102, 104) to the same side of the midframe (106) about 90°, the bicycle can be placed into other configurations including a walker, a rolling seat, and a chariot to carry packages or a person.

### RELATED APPLICATION

This application claims the benefit of U.S. Provisional Application No. 62/842,241, filed on May 2, 2019. The entire teachings of the above application are incorporated herein by reference.

### BACKGROUND

Bicycles comprising front and rear wheels mounted to a frame with handlebars, seat and drive pedals are well known. Also known are bicycles driven by electric motors.

### SUMMARY

An electric bicycle comprises a midframe and a pedal driven generator supported by the midframe with pedals extending to opposite sides of the midframe. Each of front and rear wheels comprises a rotating tire. Each wheel is mounted to the midframe with a swivel mount, the wheels being configured to swivel from in-line positions to collapsed positions on opposite sides of the midframe. A handlebar is mounted through a handlebar support to the front wheel and a seat is mounted through a seat support over the rear wheel. A first wheel motor in a first one of the front and rear wheels comprises a stator fixed to the midframe and a rotor that drives the tire of the first wheel. A current source is charged by the pedal driven generator, and electronics control charging of the current source from the pedal driven generator and delivery of power to the wheel motor from the current source.

One or each of the front and rear wheels supports a wheel motor. Each wheel motor may comprise a stator fixed to the midframe and a rotor that drives the tire of the wheel. Each wheel motor may also be configured to operate as a generator. The pedal driven generator may also be operable as a motor.

The bicycle may be collapsed to the extent that the wheels are positioned to roll in parallel directions. To that end with simple joints, each swivel mount may comprise a single axis joint that swivels about a tilted swivel axis.

Each stator may comprise opposed rings forming a wheel rim, and the rotor may be positioned between the stator rings and support the tire. The center region of the wheel within the stator may be open. The pedal driven generator may comprise a rotor ring to which the pedals are mounted and a stator ring fixed to the midframe. The pedals may pivot to close into an open center region of the generator.

The seat and handlebar may be configured to be repositioned to enable a rider to pedal the bicycle as a unicycle when the wheels are in the collapsed position. In that configuration, the bicycle may be used for exercise in a fixed location or limited area. It may even be configured to stand stationary as the pedals are driven.

As an alternative to the collapsed position, the bicycle may be configurable to swivel the front and rear wheels to the same side of the midframe, perpendicular to the midframe. In that configuration the bicycle may be configured as a walker with the handlebar and seat removed, the handlebar support and seat support serving as handles. Alternatively, a first portion of the midframe to which the front and rear wheels are mounted may be upright and another portion of the midframe pivoted from the first portion to serve as a seat. As another alternative, after the wheels are swiveled to the same side of the midframe, the wheels are rotated to position the midframe close to and along the ground to support a load. The wheels may be swiveled further to meet each other away from the ground.

The handlebar support and the seat support may each be mounted to swivel about a transverse axis, and the handlebar and seat may each rotate about the respective support.

The midframe may comprise a curved tube coupled at opposite ends to the stator of the front wheel, one end adjacent to the handlebar support. The swivel mount may include a swivel joint in the tube displaced from the handlebar support. The midframe may further comprise a curved tube coupled at opposite ends to the stator of the rear wheel, one end adjacent to the seat support. The swivel mount of the rear wheel may comprise a swivel joint in the tube displaced from the seat support.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a side view of an electric power bicycle embodying the present invention;

FIG. 2 is a perspective view of the bicycle of FIG. 1;

FIG. 3 is a side view of an alternative embodiment of the invention including an additional midframe segment;

FIG. 4 is a side view of an alternative embodiment with a relocated seat support;

FIG. 5 is a side view of an embodiment incorporating the features of FIGS. 3 and 4;

FIG. 6 is a front, end view of the embodiment of FIG. 1;

FIG. 7 is a top view of the embodiment bicycle of FIG. 1;

FIG. 8 through FIG. 11 are top views of the bicycle of FIG. 1 being collapsed, with the seat relocated below the rear swivel joint;

FIG. 12 is a side view of the collapsed bicycle with the handlebar and seat relocated for carrying;

FIG. 13 is an end view of the compact configuration of FIG. 12;

FIGS. 14 and 15 are side views like FIG. 12 but with the handlebar position at two different locations;

FIG. 16 is a perspective view of the collapsed bicycle with the handlebar and the seat repositioned for unicycle operation;

FIG. 17 is a top view of the configuration of the FIG. 16;

FIG. 18 is a front perspective view of the configuration of FIG. 16;

FIG. 19 is a rear end view of the configuration of FIG. 16;

FIG. 20 is a perspective view of an alternative configuration of the bicycle of FIG. 3 configured as a walker;

FIG. 21 is an end view of the walker configuration of FIG. 20;

FIG. 22 is a side view of the walker configuration of FIG. 20;

FIG. 23 is a top view of the walker configuration of FIG. 20;

FIG. 24 is a perspective view of the walker configuration of FIG. 20 with the midframe addition tilted forward;

FIG. 25 is an end view of the configuration of FIG. 24 with the handlebar attached;

FIG. 26 is a perspective view of the configuration of the FIG. 25;

FIG. 27 is a perspective view of an alternative configuration configured as a chariot;

FIG. 28 is a top view of the chariot configuration of FIG. 27;

FIG. 29 is an end view of the chariot configuration of FIG. 27;

FIG. 30 is a side view of the chariot configuration of FIG. 27;

FIG. 31 is a perspective view of the chariot configuration of FIG. 27 with a package mounted on the chariot;

FIG. 32 is an end perspective view of an alternative compact configuration for carrying packages;

FIG. 33 is a top view of the configuration of FIG. 32;

FIG. 34 is an end view of the configuration of FIG. 32;

FIG. 35 is a top perspective view of the configuration of FIG. 32;

FIG. 36 is a top perspective view of the configuration of FIG. 32 with a package mounted for transport;

FIG. 37 is a side perspective view of the configuration of FIG. 36;

FIG. 38 is a perspective view of the configuration of FIG. 32 modified to carry a user;

FIG. 39 is a side view of the configuration of FIG. 38;

FIG. 40 is a rear end view of the configuration of FIG. 38;

FIG. 41 is a top view of the configuration of FIG. 38;

FIG. 42 is an alternative configuration like that of FIG. 24 but modified for seating on the midframe segment;

FIG. 43 is a perspective view of the configuration of FIG. 42 with the addition of seating net;

FIG. 44 is an end view of the configuration of FIG. 42;

FIG. 45 is a side view of the configuration of FIG. 42;

FIG. 46 is a top view of the configuration of FIG. 42;

FIG. 47 is an electrical block diagram of the electronic control used in each embodiment of the invention.

### DETAILED DESCRIPTION

A description of example embodiments follows.

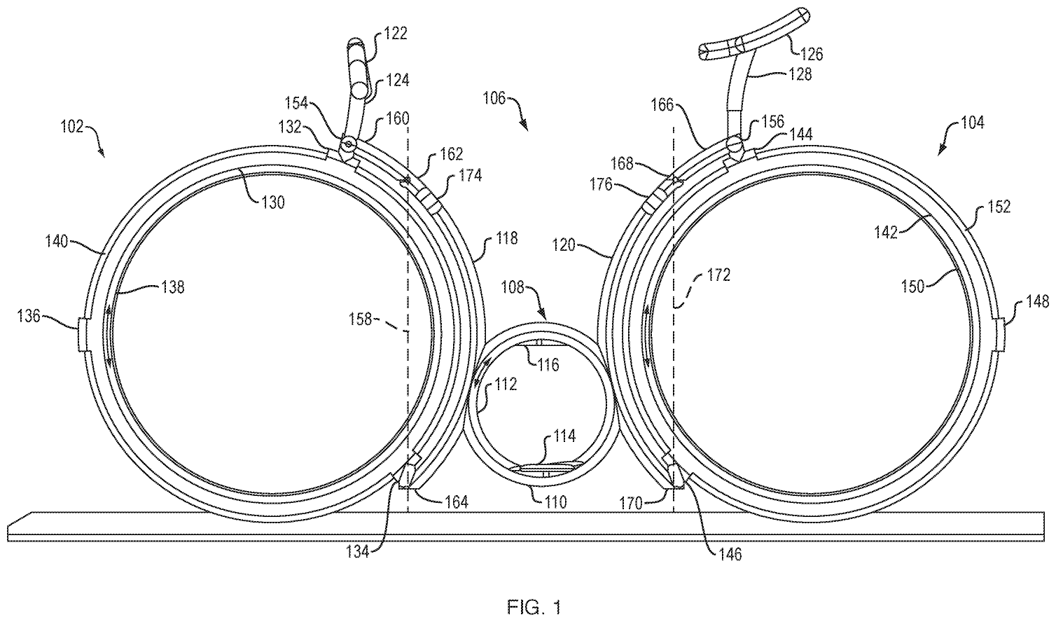

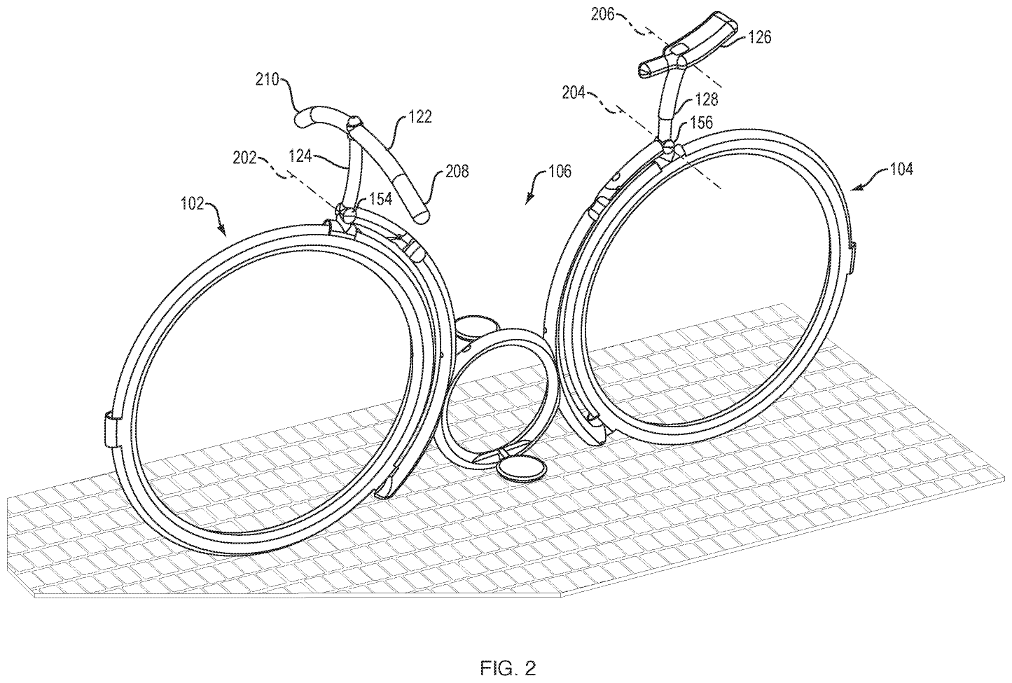

FIGS. 1 and 2 provide a side view and perspective view of an electrically powered bicycle. The bicycle includes a front wheel 102, a rear wheel 104 and a midframe 106. The midframe 106 includes a generator-motor 108. The generator-motor 108 includes a rigid stator 110, that forms part of the midframe structure. A rotor 112 is mounted by ring bearings to the stator to rotate within the stator. The rotor 112 supports pedals 114 and 116 to enable a user to rotate the rotor.

The midframe 106 also includes a front tubular structure 118 that may be curved to follow the curve of the wheel 102. Similarly, the curved tubular structure 120 follows the curve of the rear wheel 104 and completes the midframe. The tubular structures 118 and 120 carry batteries or capacitors to be charged by the generator motor 108 and the two drive wheels 102 and 104 as described below. The frame tubes 118 and 120 also carry electronics for controlling charging and discharging of the battery or capacitors and to control speed and inertial force applied to the wheels and generator as described below.

A handlebar 122 is mounted to the top end of the frame tube 118 through a telescoping support 124. The support 124 is mounted to the tube 118 through a pivot joint 154 that allows the handlebar to be tilted forward or backward about a swivel axis 202 illustrated in FIG. 2.

A seat 126 is mounted to the upper end of the rear frame tube 120 through a telescoping support 128. The support 128 is mounted to the tube 120 through a swivel joint 156 that swivels about an axis 204 illustrated in FIG. 2. The seat 126 is mounted to the support 128 at a pivot joint that allows the seat to be pivoted about an axis 206 illustrated in FIG. 2.

The front wheel comprises a circular motor 130, 138 that drives the tire 140. The motor includes a left and right stator structures 130 that are fixed to the frame tube 118 at the top end by U-shaped bracket 132 and at the bottom end by U-shaped bracket 134. The stator elements are joined at the front of the bike by a U-shaped bracket 136. A rotor 138 mounted by ring bearings within the stator elements is driven by electric current through the stator elements. The tire 140 is mounted to the rotor 138 to be driven with the rotor.

A similar wheel structure is provided at the rear of the bicycle. Stator elements 142 are joined by U-shaped brackets 144, 146 and 148 and mounted to the ends of the rear frame tube 120 at the brackets 144 and 146. A rotor 150 is mounted through ring bearings within the stator elements and drives the rear tire 152. Thus, it can be seen that each of the wheels comprises a rigid stator structure that forms a rim of the wheel and that is rigidly coupled to the midframe 106. A rotor and tire rotate relative to each set of stator elements to drive the bicycle in forward or reverse motion.

To steer, the front wheel 102 can be turned relative to the midframe 106 about a vertical axis 158. To that end, a top segment 160 of the frame tube 118 is joined to the main body of the frame tube 118 through a swivel joint 162. The stator elements 130 are mounted to the lower end of the frame tube 118 through another swivel joint 164. By rotating the handlebar 122, the front wheel is turned in a manner like that of a conventional bicycle. In addition, the swivel action enables reconfiguration of the bicycle as described in detail below.

Turning of the rear wheel is also enabled, not for turning during operation of the bicycle or for the configuration of FIG. 1, but for reconfiguring the bicycle as described below. To that end, an upper end segment 166 of the frame tube 120 swivels about a vertical axis 172 at a swivel joint 168. Also, the stator elements 142 are mounted to the lower end of the frame tube 120 at a swivel joint 170.

The rotors 138 and 150 can be back driven to become a generator. There are many motor-generator candidate designs including Halbach array, gearless, brushless DC motor-generators and Lorentz force (homopolar or Faraday) motor-generator designs. The design of such motor-generators is well known.

The rotors 138, 150 and stators 137, 142 are connected via slender ring bearings (e.g., incorporating balls, rollers or needles). In another embodiment, these ring bearings could incorporate very low sliding friction materials such as graphene.

Each motor-generator can be independently computer controlled and, when acting as a motor, generates torque which propels the bike using energy stored in the energy storage units located in the tubular frame. When riding down hills, the motor-generators now act as generators and convert the kinetic energy of the bike and rider (and any goods adding to the payload) to stored electrical energy (in the energy storage elements inside the tubular frames).

The rate at which energy is extracted (i.e., power) from the motor-generators acting as generators determines the angular velocity dependent torque (i.e., viscosity) as seen by the internal computer control system hidden in the tubular frame. For example, during a down-hill ride, if the power extracted from the generators is high, then the bike will slow down (via viscous drag exerted by the motor-generators as they harvest energy). Indeed during aggressive braking a maximum power is extracted from the generators (i.e., from both wheels).

Braking at a low speed may use another strategy in which the front and/or rear wheels act as motors to generate torques opposing forward motion (i.e., energy is consumed from the energy storage elements).

The energy storage elements hidden in the tubular frame might be batteries of some type (e.g., lithium ion batteries) having a suitably high power and high energy density, or in another embodiment might be capacitors (having a suitably high power and high energy density).

The smaller mid generator-motor 110, 112 located between the front and rear wheels can be of a similar design to those used in the front and rear wheels.

Torques generated by the bike rider are transmitted via the pedals 114, 116 to the rotor 112 of the middle generator-motor unit. The electrical energy generated is then stored in either or both types of energy storage units. The rate of energy (power) extracted from the torques generated by the bike rider is computer controlled. This enables the rider to control (via the computers, power electronics and all three motor-generators) the ratio between power exerted by the rider on the pedals and the power delivered to the road surface by the front and rear motor-generators acting as motors. In this way a very wide range of ratios between the human rider input power and the power exerted by the bike on the road may be selected. In this way the system acts like a traditional bicycle gear system but without the need for physical gears. Indeed, the system enables a continuous range of “gear ratios” to be generated.

The rider may control speed and pedal resistance through sensor grips 208 and 210 on the handlebar. For example, the user may exert a rotary torque on the right grip to speed up (rotation torque forward) and slow down (rotation torque backward) or exert a rotary torque on the left grip to change the drag force.

Note the absence or need for any chain connecting the pedals to the rear wheels and the absence or need for any physical gears.

It is to be understood that the three motor-generators (front, mid and rear) are controlled with power amplifiers which both deliver power from the energy storage units and conversely can harvest kinetic energy from the motor-generators (front, rear), as driven by the road surface, and deliver that energy to the energy storage units.

A solenoid hidden in the frame tube 118 at the swivel joint 162, and possibly another at swivel joint 164, can be activated to lock the front wheel into a variety of positions when the bike is reconfigured into non-traditional form as described below. A similar solenoid is associated with the rear wheel at joint 168, and possibly at joint 170. This solenoid locks the rear wheel into the forward pointing orientation (as shown) when the bike is in the traditional configuration or into other positions described below.

Multi-axis force sensors embedded in the handlebar support 124 and the rear seat support, respectively, are used in both traditional (as shown) and nontraditional (as shown in subsequent figures) bike configurations to control the bike by a rider or to allow a human to walk beside the bike and via gentle forces exerted on either the handlebar support of the seat support to guide the bike. The same sensors are used in the nontraditional bike configurations (show below) to issue commands to the bike (such as to set its speed or direction).

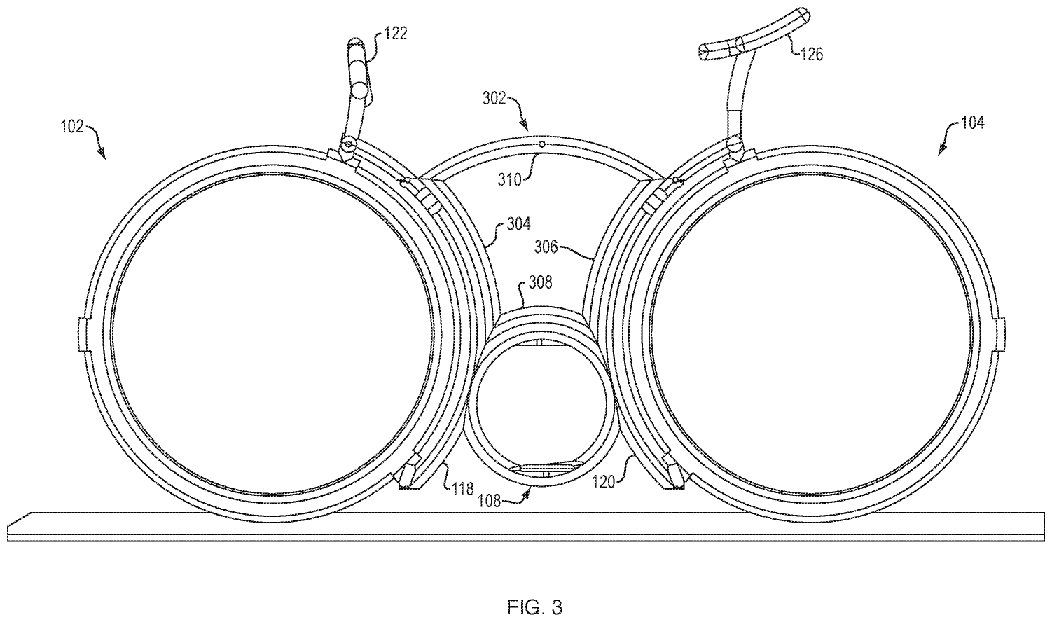

FIG. 3 shows another embodiment substantially the same as that of FIGS. 1 and 2 except that it additionally includes an additional frame 302 as part of the midframe. Curved tubes 304 and 306 are positioned adjacent to frame tubes 118 and 120, lower tube 308 is positioned adjacent to the generator-motor 108, and an upper tube 310 bridges the tubes 304 and 306. The additional frame segment 302 increases rigidity of the frame and provides additional space for power storage batteries and capacitors and for electronics. The frame 302 also provides additional function in other configurations of the bicycle described below.

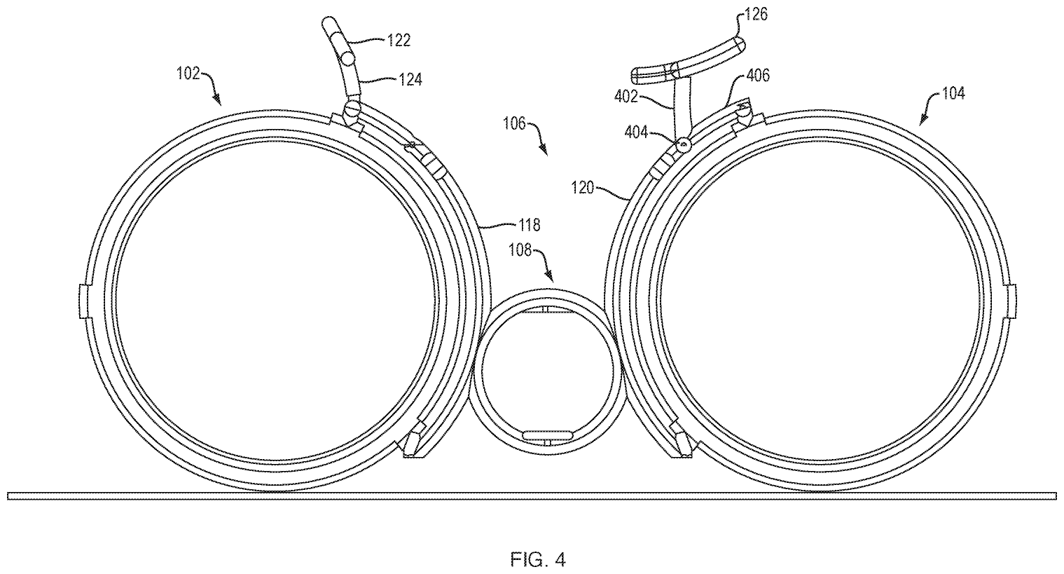

FIG. 4 illustrates another embodiment that is substantially the same as that of FIGS. 1 and 2 with an alternative mounting of the seat. Here, the telescoping seat support 402 is mounted at a lower end of an upper segment 406 of the rear frame tube 120 at a swivel joint 404. FIG. 4 also shows the handlebar 122 and the handlebar support 124 swiveled forward relative to what is shown in FIG. 1.

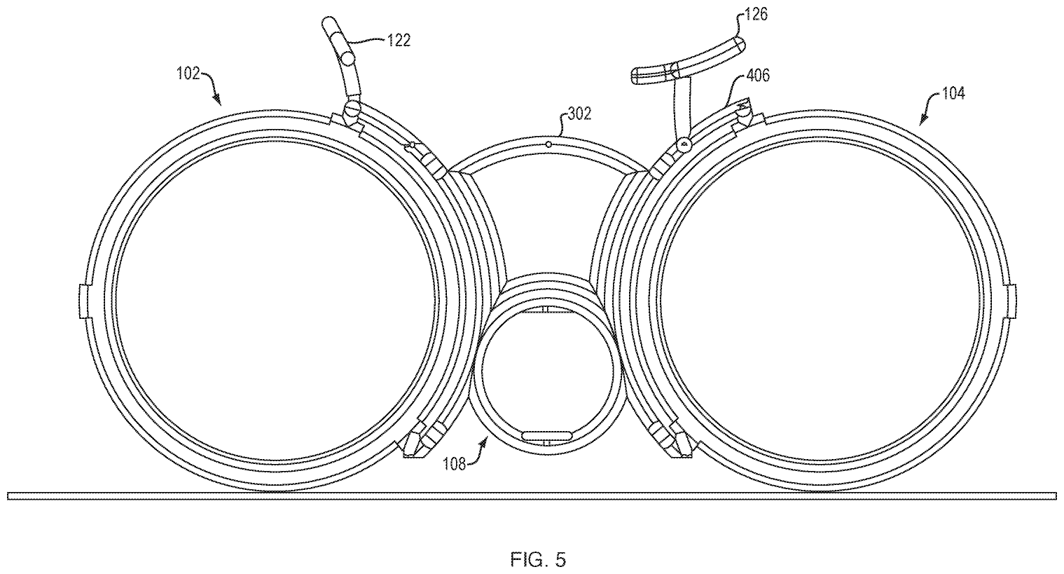

FIG. 5 illustrates a bicycle identical to that of FIG. 4 with the addition of the additional frame segment 302 previously shown in FIG. 3.

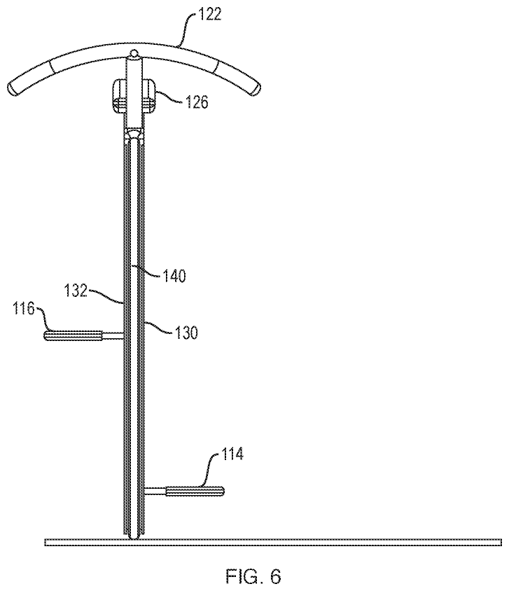

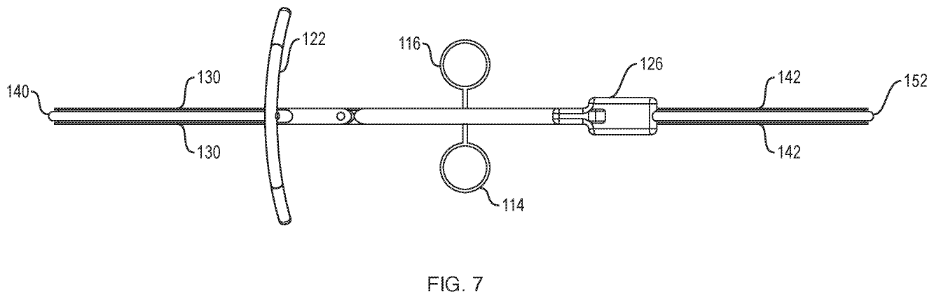

FIG. 6 is a front view of the bicycle of FIGS. 1 and 2; and FIG. 7 is a top view of the bicycle of FIGS. 1 and 2.

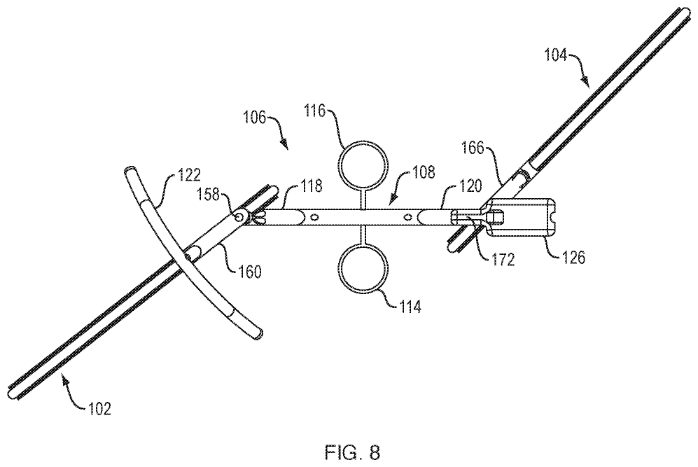

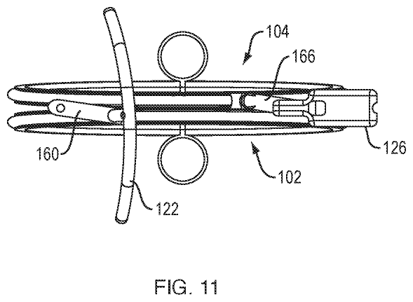

FIGS. 8-11 are top views showing the bicycle being folded to reconfigure it into a collapsed configuration. In order to reconfigure the bike in the front and rear, solenoids at swivel joints 162 and 168 are temporarily activated to unlock the bike such that the front and rear wheels are free to swivel about their respective swivel axes 158 and 172. Once this is done, the bike rider may swivel the front and rear wheels around their respective swivel axes 158, 172 by almost 180 degrees with the result that the front and rear wheels are adjacent to each other on either side of the midframe 106 as shown in FIG. 11.

In FIGS. 8-11, the seat 126 is seen to be relocated and clamped on the frame tube 120 at a position below the swivel joint 168. Accordingly, it does not rotate with the rear wheel 104. If the seat were retained at the upper end of segment 166 of the frame tube 120 as shown in FIG. 1, it would rotate with the wheel. In FIG. 11, the seat would be shown further to the left and pointing in the reverse direction.

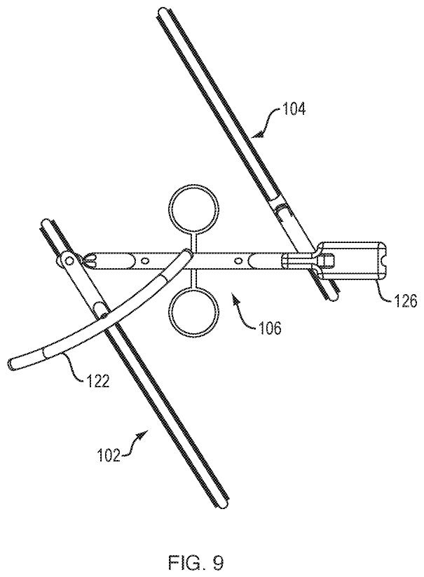

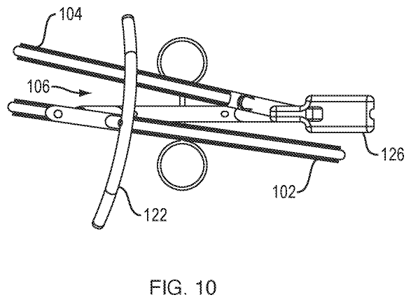

In FIG. 8, the front and rear wheels 102, 104 are swiveled about respective swivel axes 158 and 172 toward opposite sides of the midframe 106. In FIG. 9, the wheels are swiveled further, and in FIG. 10, the wheels are swiveled almost to their full extent alongside the midframe 106. FIG. 11 shows the fully collapsed configuration in a top view. In FIG. 11, the pedals extend through the front and rear wheels 102, 104 as enabled by the spokeless wheels that are open in the center region of the wheels.

The bicycle can be collapsed manually, or the motors in the front and rear wheels can aid in (or completely and autonomously execute) this transformation. The front and back wheels are first swiveled a bit off alignment. Then the front wheel is driven in reverse and the back wheel is driven forward in a back a forth motion to achieve the auto-folding.

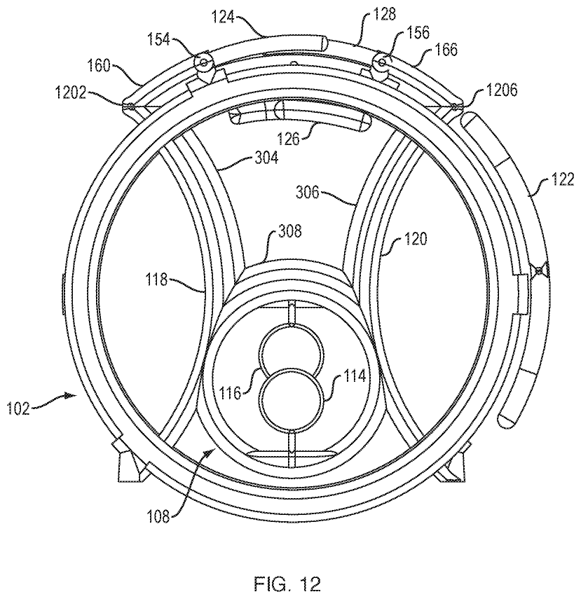

From the collapsed configuration of FIG. 11, the bicycle can be further compacted as illustrated in the side view of FIG. 12. Here, the left pedal 114 is swiveled up and the right pedal 116 is swiveled down to position each fully within the open region within the generator-motor 108. FIG. 12 also shows that the upper frame tube segments 160 and 166 extend alongside the wheels 102 and 104. This effect results from the mating surfaces 1202, 1206 of the upper segments 160, 166 to the mainframe tubes 118 and 120 being perpendicular to the swivel axes 158, 172 but angled relative to the center axes of the tubes 118 and 120. In FIG. 12, the handlebar has been removed from the handlebar support 124, which is now swiveled about the swivel joint 154 to be close to the wheel 102. Similarly, the seat has been removed from the seat support 128, which is pivoted about swivel joint 156 to be close to the rear wheel 104. The seat has been placed inside the wheels and may be magnetically coupled to or spring clamped to or otherwise coupled to the wheels to serve as a shoulder pad in carrying the collapsed bicycle on one shoulder. The handlebar 122 may be clamped to or magnetically or otherwise coupled to one or both wheels. In FIG. 12, it is shown positioned to the right of the wheels.

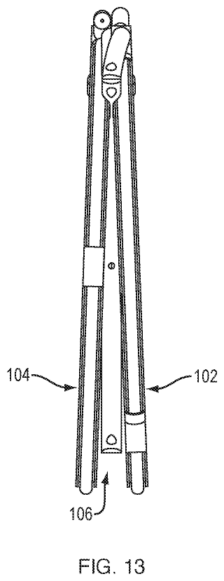

It can be understood that, if the bicycle were collapsed about vertical axes 158, 172, the wheels 102, 104 would collide with the midframe 106 before the wheels and midframe reached a parallel orientation. To collapse the wheels into a parallel configuration, double axis joints 162, 168 can be used. But to avoid the complexity of a double axis joint, the system shown relies on single axis joints 162, 168 where the swivel axes 158, 172 are slightly tilted from vertical, one to one side and the other to the other side. The result is best seen in FIG. 13, which shows an end view of the collapsed bicycle of FIG. 12. In this view, the wheels 102 and 104 are no longer vertical as they were in the standard riding configurations of FIGS. 1 through 7. With the tilted swivel axes, the wheels are positioned closer together at the upper end but are split apart at the lower end. To allow for the more compact folding, a notch 174 (FIG. 1) is provided in the frame tube 118, and a notch 176 is provided in the frame tube 120. In this folded configuration, the rear wheel 104 rests in the notch 174, and the front wheel 102 rests in the notch 176. The result is a collapsed configuration in which the wheels are no longer parallel but which allows the wheels to roll in parallel directions. The spread of the wheels at ground also leads to greater stability. The wheels close to each other at the top bring the handlebar and seat supports closer together in the axial direction toward a center plane for riding embodiments described below.

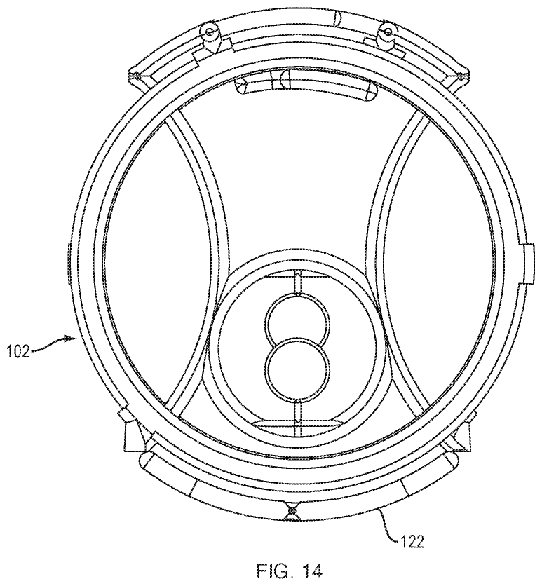

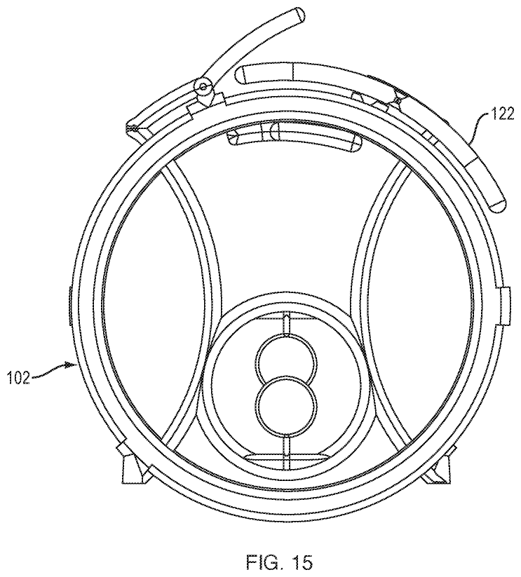

FIGS. 14 and 15 show alternative positions of the handlebar 122 coupled to the collapsed bicycle. As before, the handlebar may be clamped or magnetically coupled to one or both folded wheels.

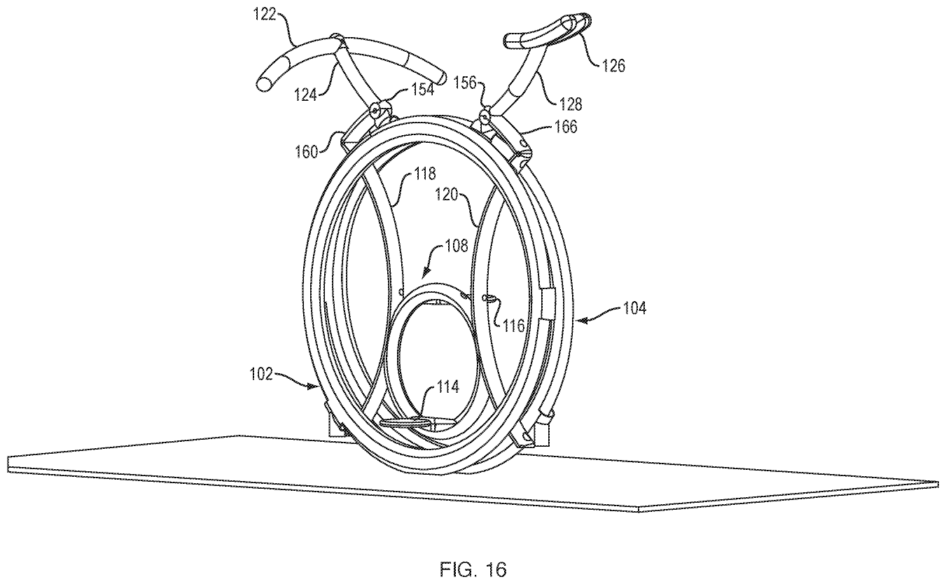

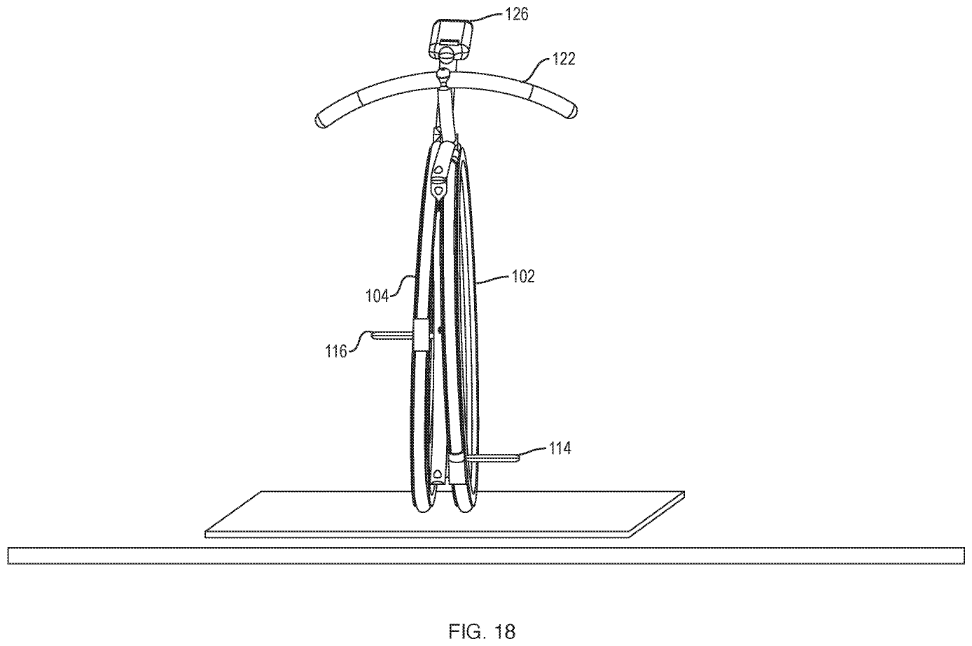

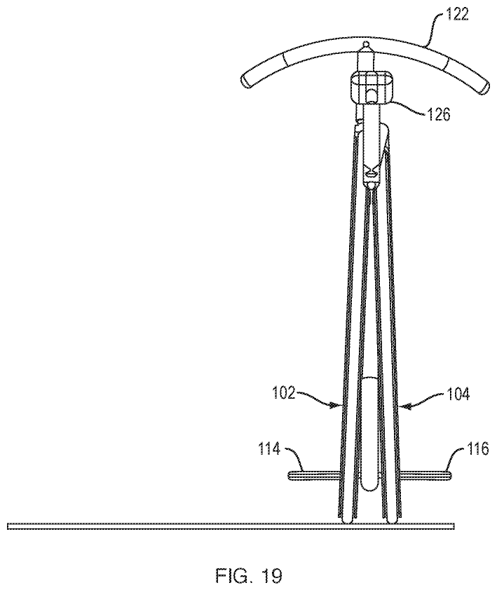

FIGS. 16-19 show the bicycle in the collapsed configuration but with the handlebar 122 and seat 126 and their respective supports retained at the joints 154, 156 as shown in the standard configuration of FIG. 1. When first collapsed, both the handlebar and seat would face in reverse directions as the handlebar 122 is shown in FIG. 11. After collapse, the end segments 160 and 166 of the frame tubes 118 and 120 are directed toward each other. The seat support 128 and handlebar support 124 are offset from each other slightly in the axial direction of the wheels due to the offset of the wheels. To obtain the position shown in FIG. 16, the handle bar 122 is rotated 180° on its support 124, and the support 124 is swiveled forward, away from the seat, on swivel joint 154. Similarly, seat 126 is rotated 180° on its support 128, and the support 128 is swiveled away from the handlebar on its swivel joint 156.

In this configuration, the bicycle may be utilized as a unicycle that has particular application as an exercise bicycle (exercycle) for exercise in a room or other close space. In this exercise configuration, the bicycle can be used to exercise the body by providing a velocity dependent torque to the pedals. The electrical energy generated by the mid motor-generator 112, 114 is stored in the energy storage modules. With gyro and accelerometer sensing, the electronics may retain the unicycle in a stable, stationary position by dithering forward and reverse rotation of the wheels. If needed, the bike in this configuration can be programmed to drive in a circle, figure eight or some other arbitrary path during exercise. Indeed, the path travelled (it might be in a living room, for example) might be coupled to a display, perhaps mounted to the handlebar, of some interesting path (e.g., mountain path) or circuit (e.g., bike race circuit).

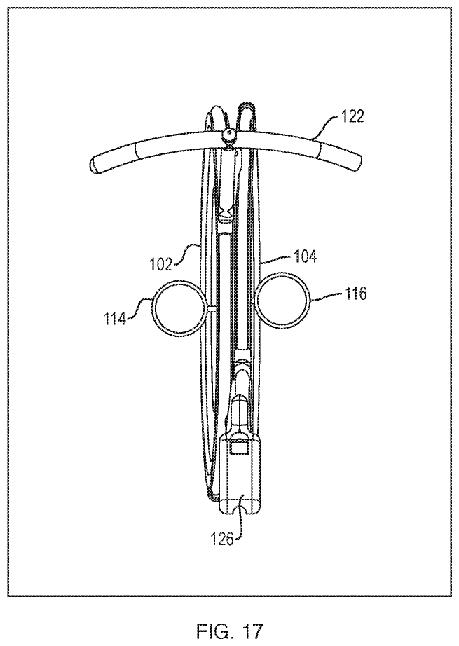

FIGS. 17-19 provide the top, front and rear views of the unicycle configuration of FIG. 16.

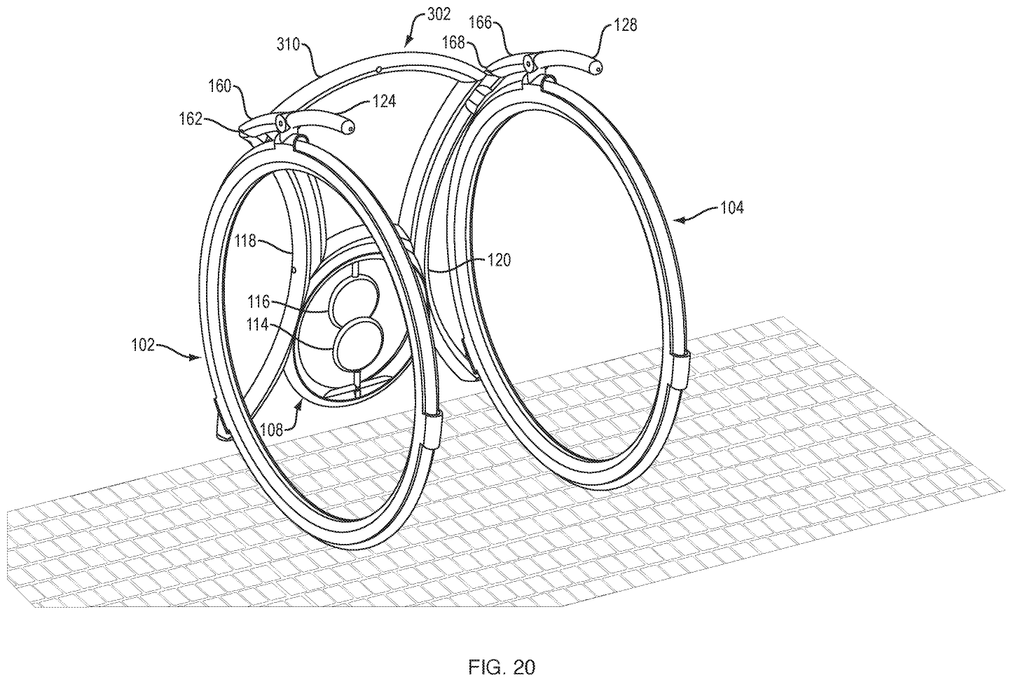

FIGS. 20-26 illustrate walker configurations of the bicycle of FIG. 3. To obtain this configuration, both wheels 102 and 104 are swiveled about swivel joints 162, 168 to the same side of the midframe by 90° and then locked in place. The end segments 160 and 166 of the frame tubes 118 and 120 also extend to the side at 90°. The pedals 114, 116 are swiveled into the collapsed position within the generator 108, and the handlebar and seat are removed. The handlebar support 124 and seat support 128, with their associated torque sensors, extend alongside the wheels as walker handles. The walker is powered and can steer under computer control by differential torques generated by the two wheels. Three axis accelerometers and three axis gyros in the bike control system are used to servo control the bike in this walker configuration to remain in the orientation as shown. A person using the bike in this walker configuration holds the bike via the handlebar support bar 124 (in one hand) and the seat support bar 128 (in the other hand). The multi-axis force/torque sensors in supports 124 and 128 are used to detect direction and speed commands from the human.

The bicycle in this walker configuration can also function as an autonomous robot (i.e. can function without a human “driver”).

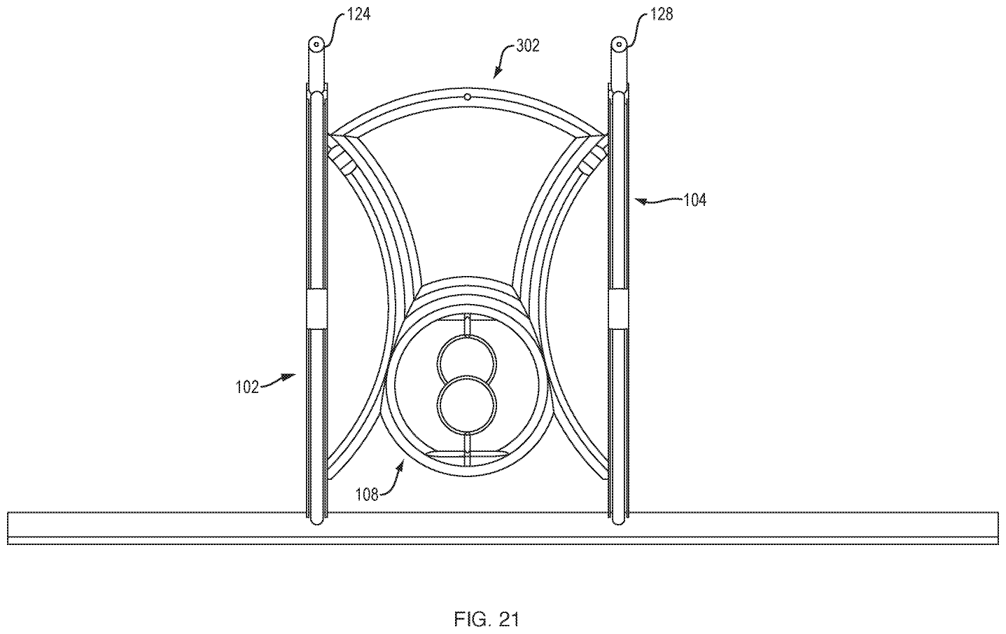

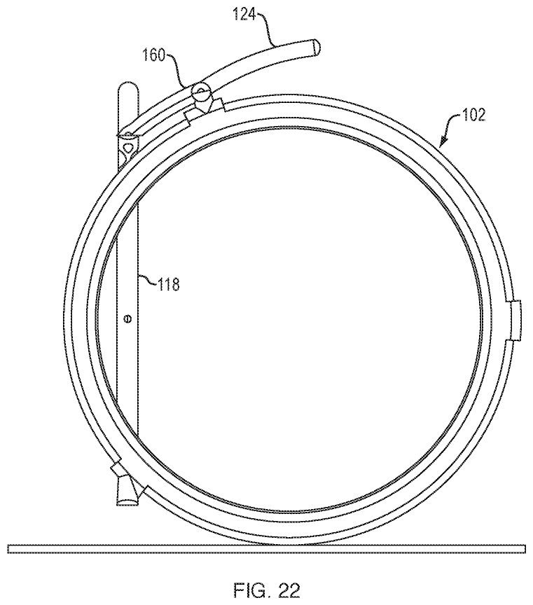

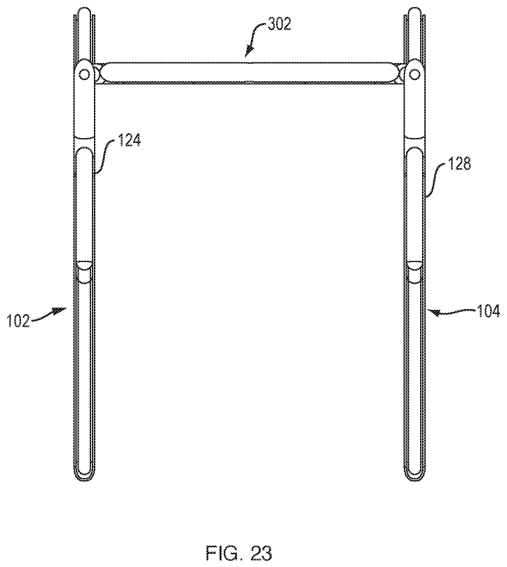

FIG. 21 shows an end view of the walker of FIG. 20; FIG. 22 shows a side view of the walker; and FIG. 23 shows a top view.

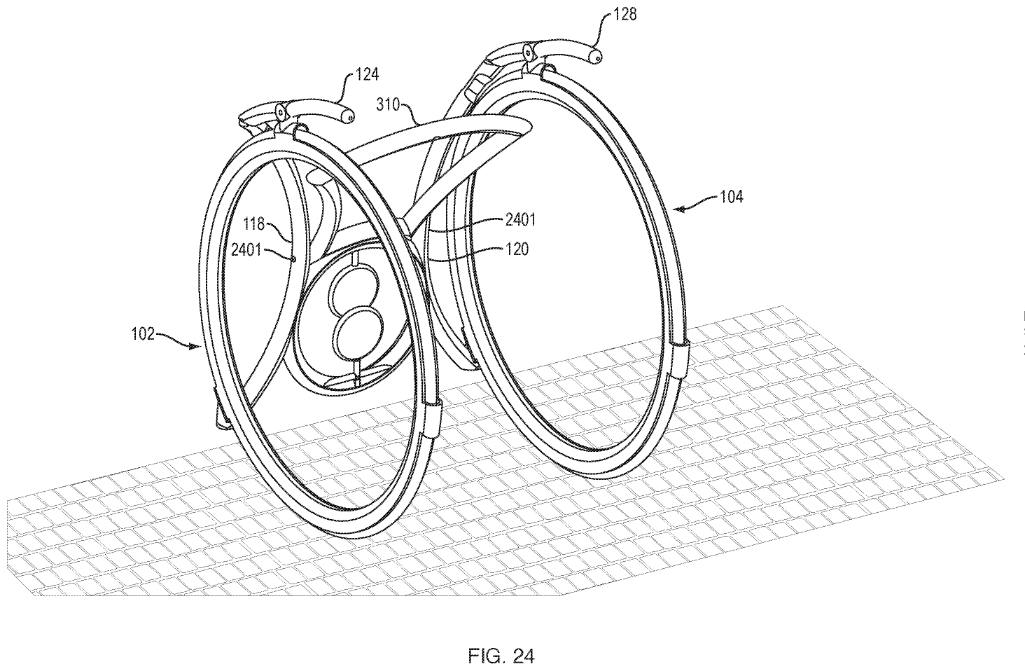

The user of the walker may also simply hold the top bar 310 of the additional frame segment 302 of the midframe. In the configuration of FIG. 24, the midframe addition 302 is tilted toward the user on pins 2401 extending through the front frame tube 118 and rear frame tube 120. This moves the top bar 310 closer to the user for more convenient grasping.

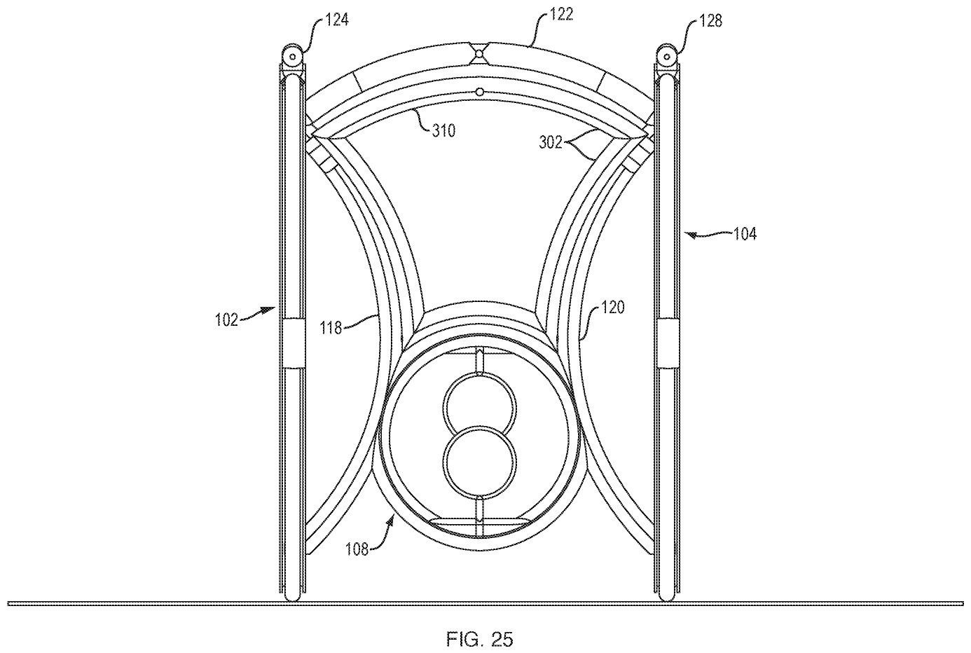

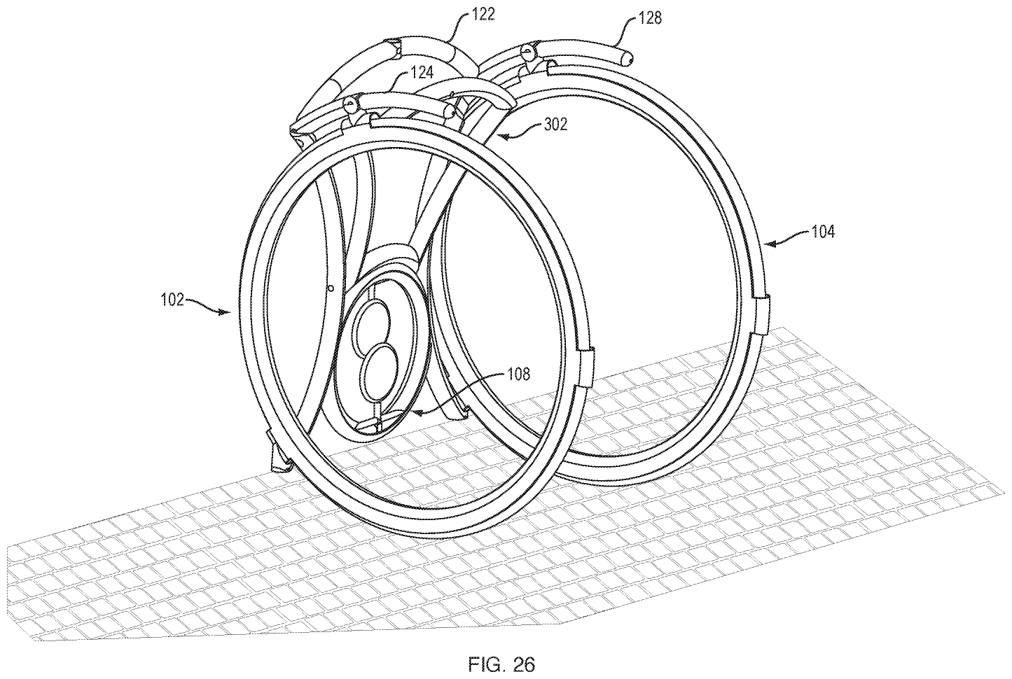

FIG. 25 is an end view of the walker of FIG. 24 with the frame addition 302 tilted toward the user, and additionally shows the handlebar mounted between the front and rear wheels. The handlebar may be mounted by magnetic coupling or spring clamp or other temporary attachment mechanism. The handlebar adds to the rigidity of the system. In a configuration where the midframe addition 302 is not included, the handle 122 would then provide an additional feature to be grasped by a user with possible control through the end hand grips 208 and 210. FIG. 26 shows a perspective view of the configuration of FIG. 25.

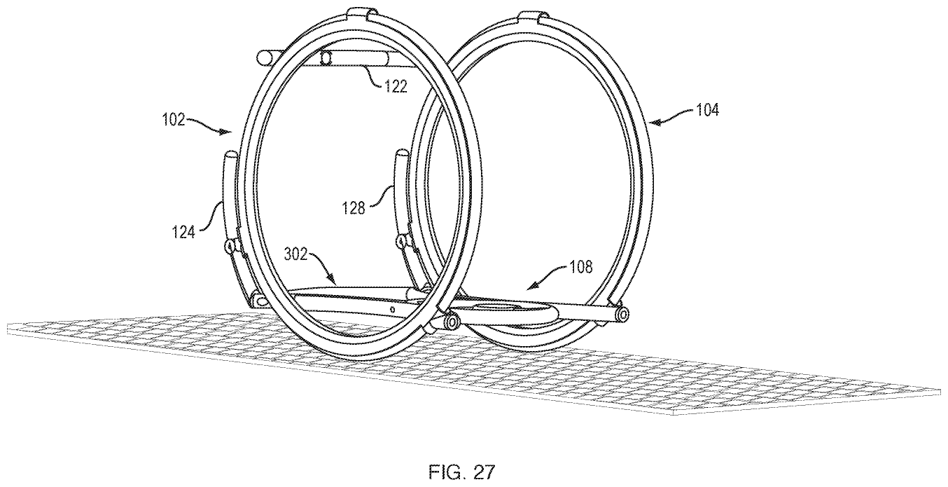

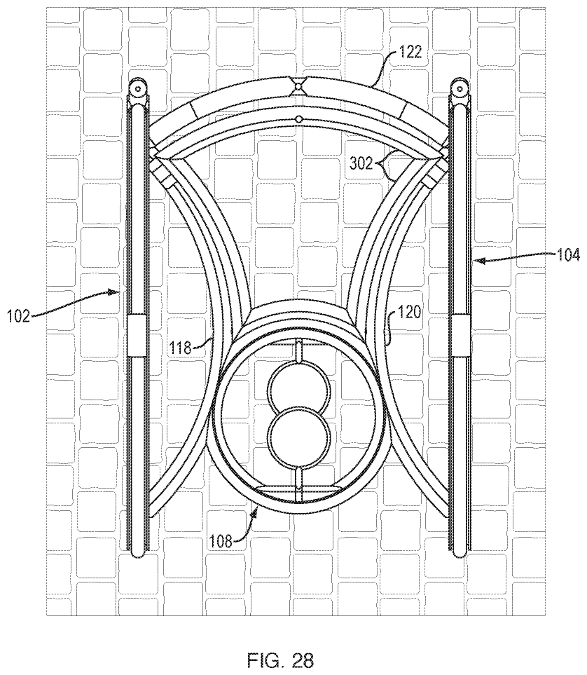

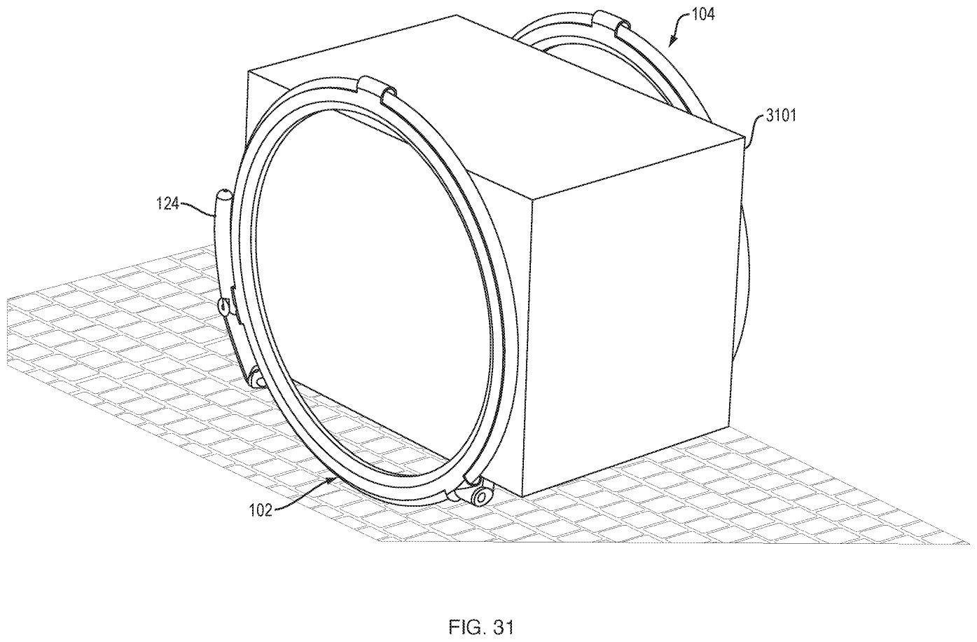

FIGS. 27-31 illustrate yet another configuration of the bicycle, a chariot configuration. Here, the bicycle is configured as in FIG. 20 but the wheel stators of the front and rear wheels 102 and 104 are rotated 90° about their center axis. This brings the midframe 302 low, alongside and parallel to the ground. This configuration can be used to transport packages supported on the midframe as illustrated in FIG. 31 or a user may stand on the midframe. In the latter case, the handlebar 122 might be connected between the stators of the wheels 102 and 104 to serve as a handlebar with handle grip controls to be gripped by the user. The handlebar support 124 and the seat support 128 might still be used by the user, but to avoid having to squat, extensions, not shown, would be added to the supports. In either case, the multi-axis force/torque sensors in the supports 124 and 128 are used to detect direction speed commands from the user. The bicycle in this chariot configuration can also function as an autonomous robot (i.e. it can function without a human driver) and might be used for package delivery among other tasks.

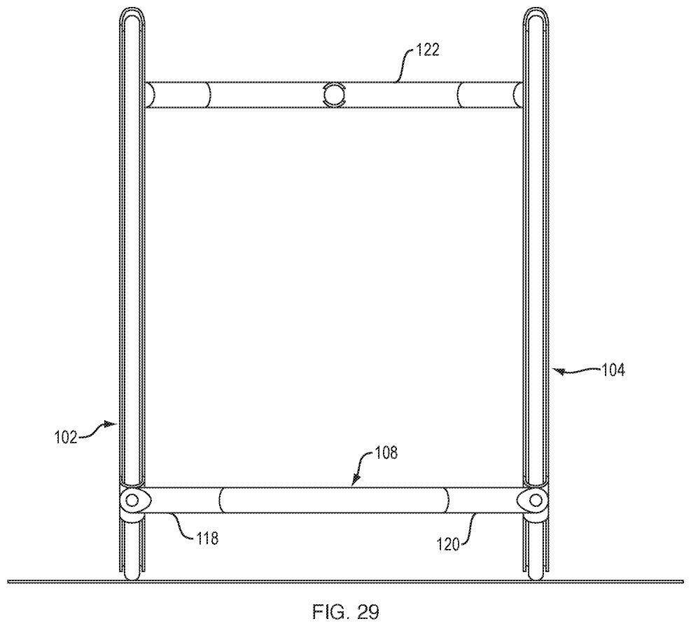

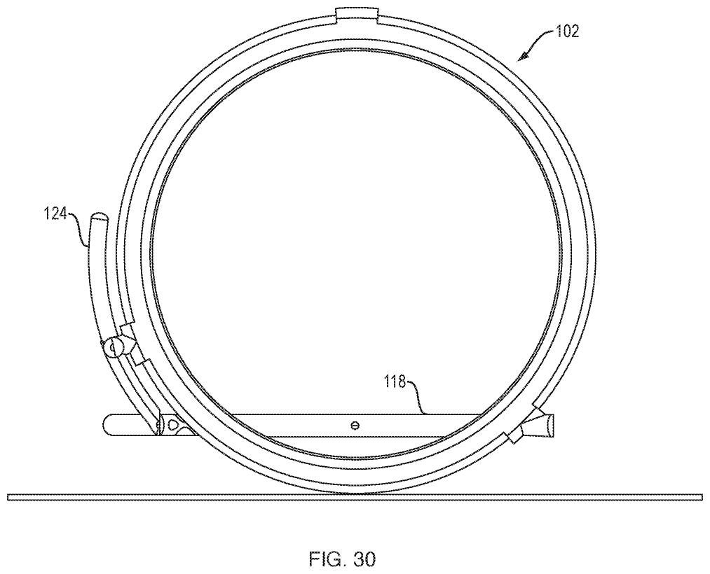

FIG. 29 shows an end view of the chariot configuration with the handlebar 122 mounted, and FIG. 30 is a side view of the chariot configuration without the handlebar.

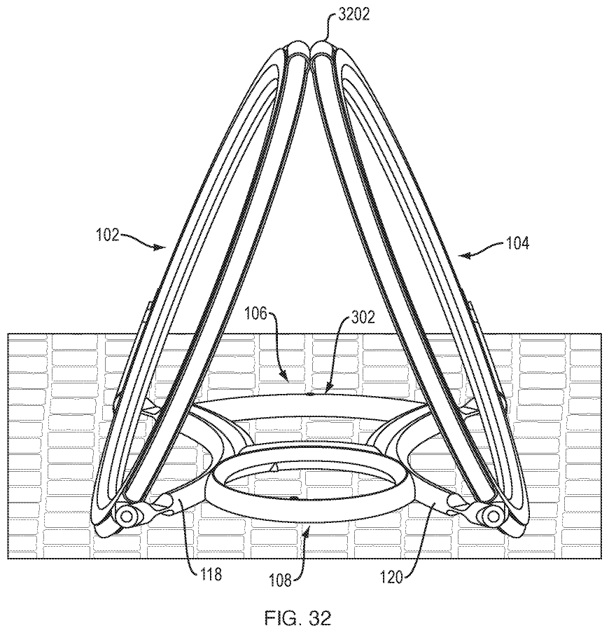

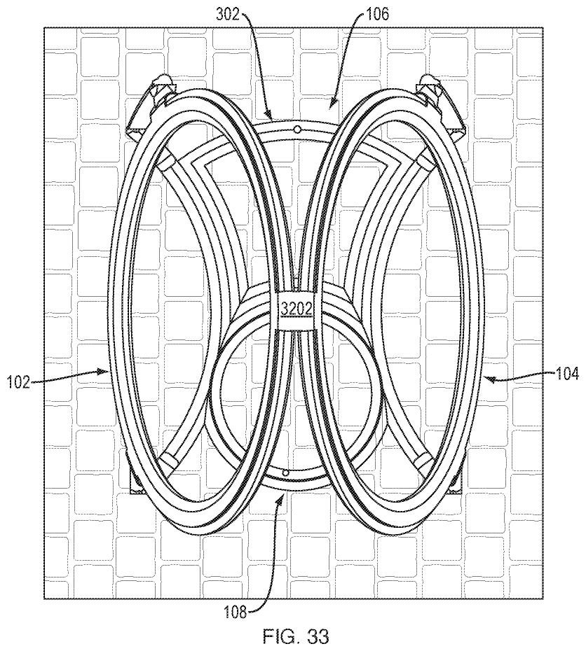

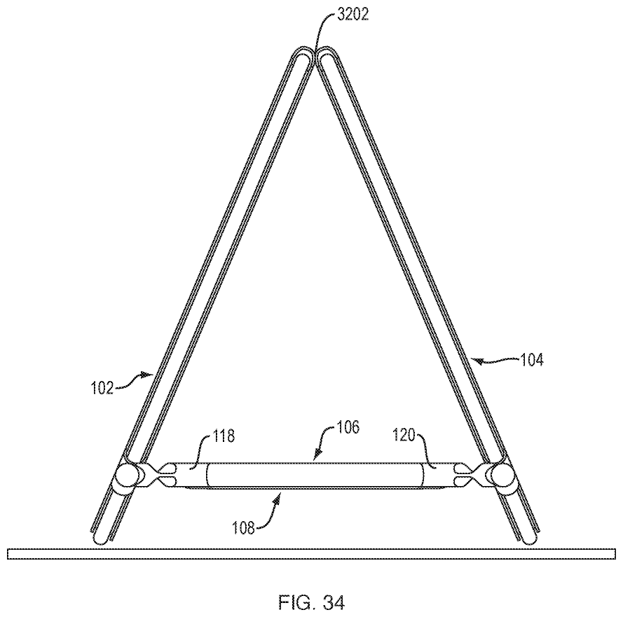

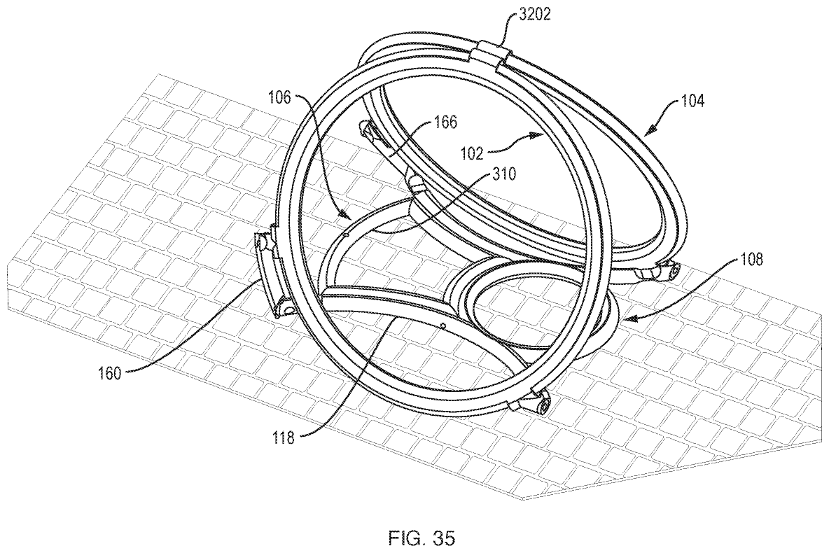

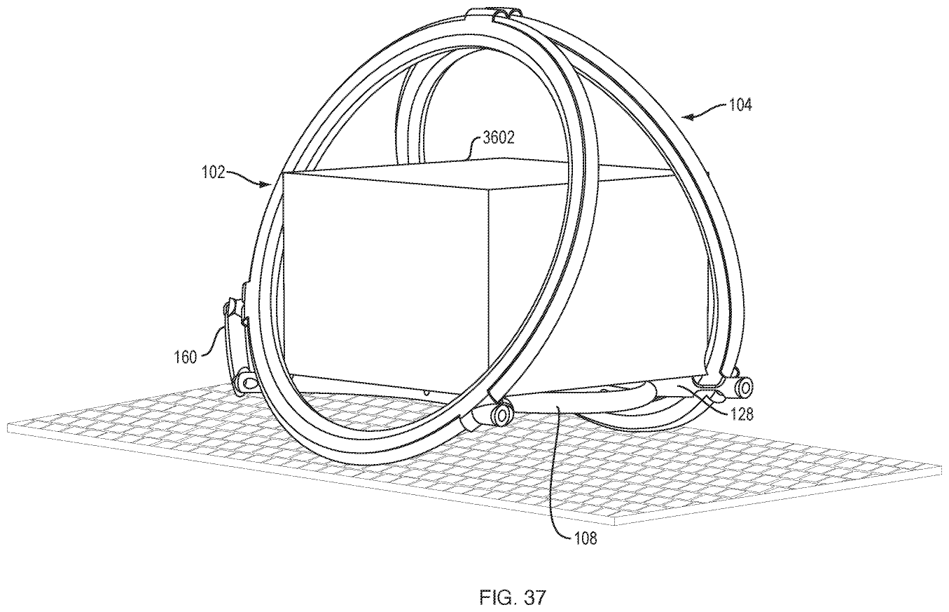

FIGS. 32-37 illustrate yet another configuration, a compact robotic configuration. This configuration is like the chariot configuration of FIGS. 27-31, but the wheels 102, 104 have been swiveled further to the same side of the midframe 106 to meet where they can be clamped together at 3202. As with the chariot configuration, this configuration can carry a package as illustrated in FIG. 37 and can be operated autonomously.

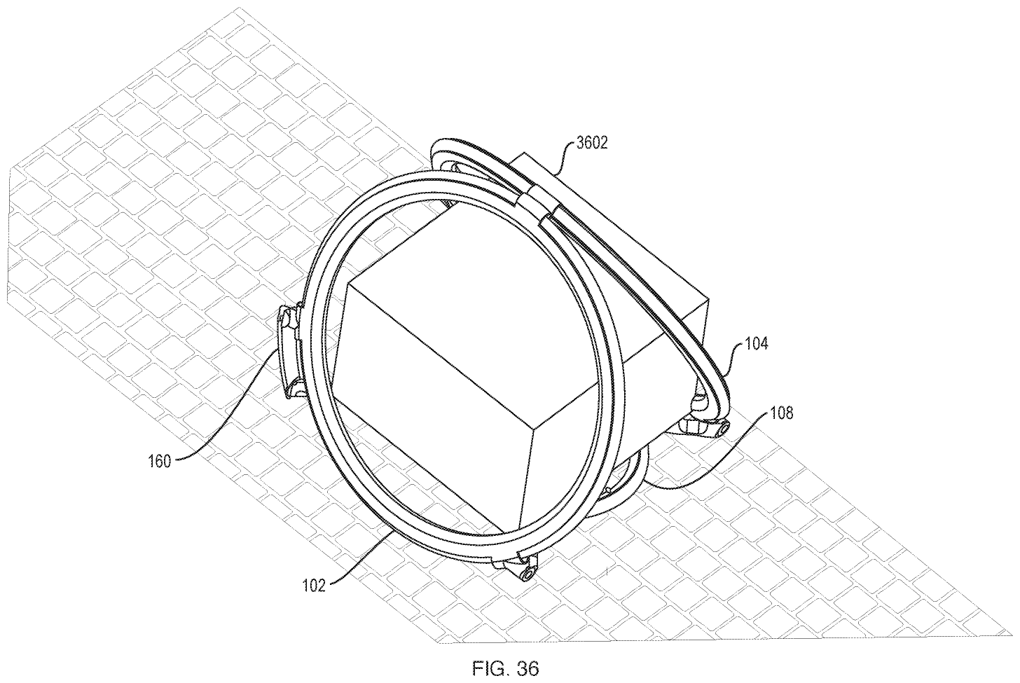

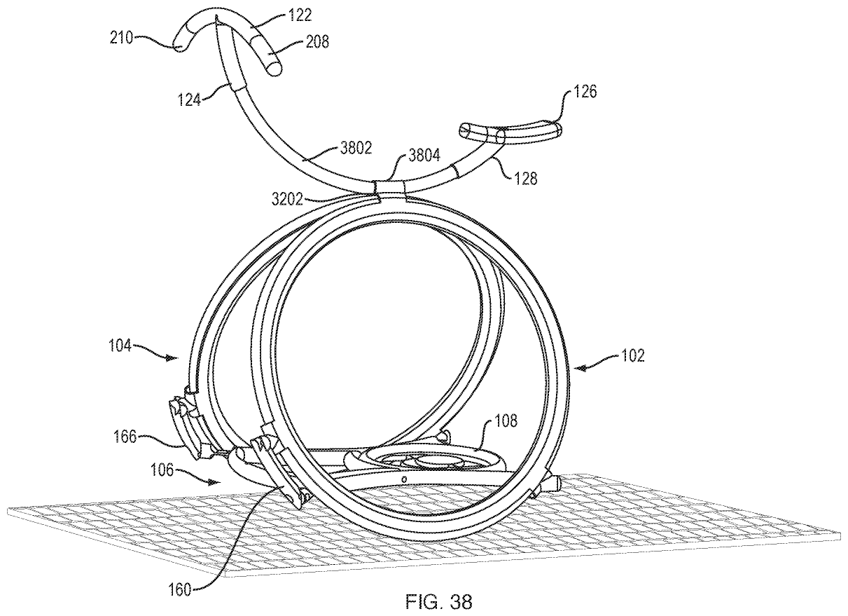

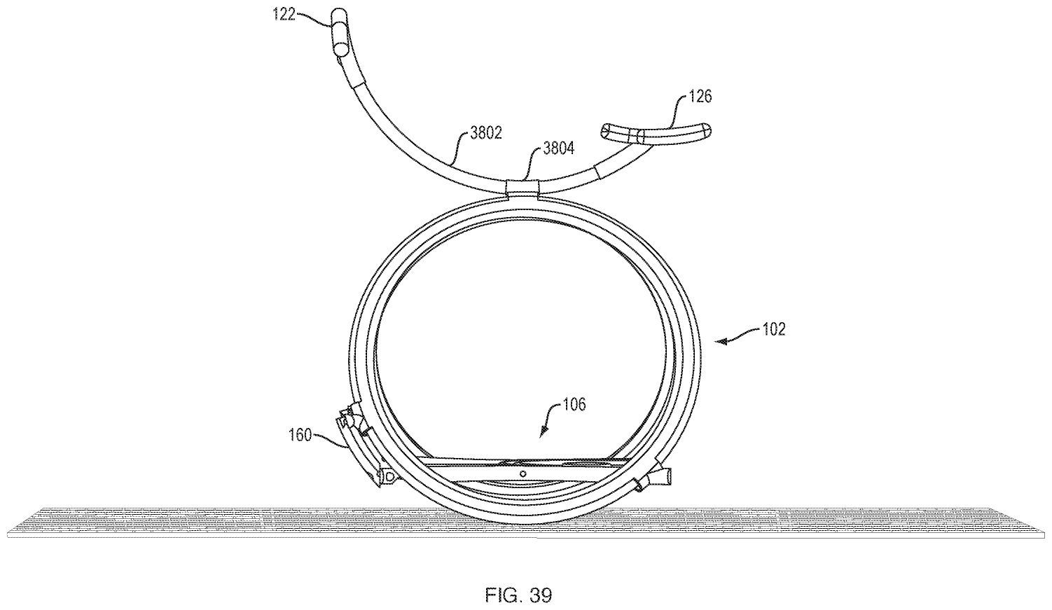

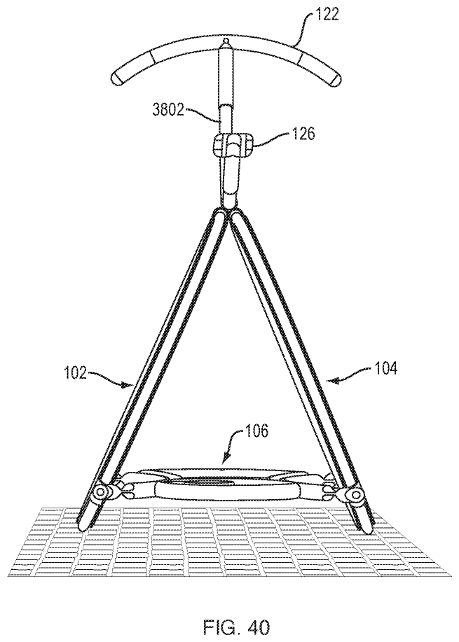

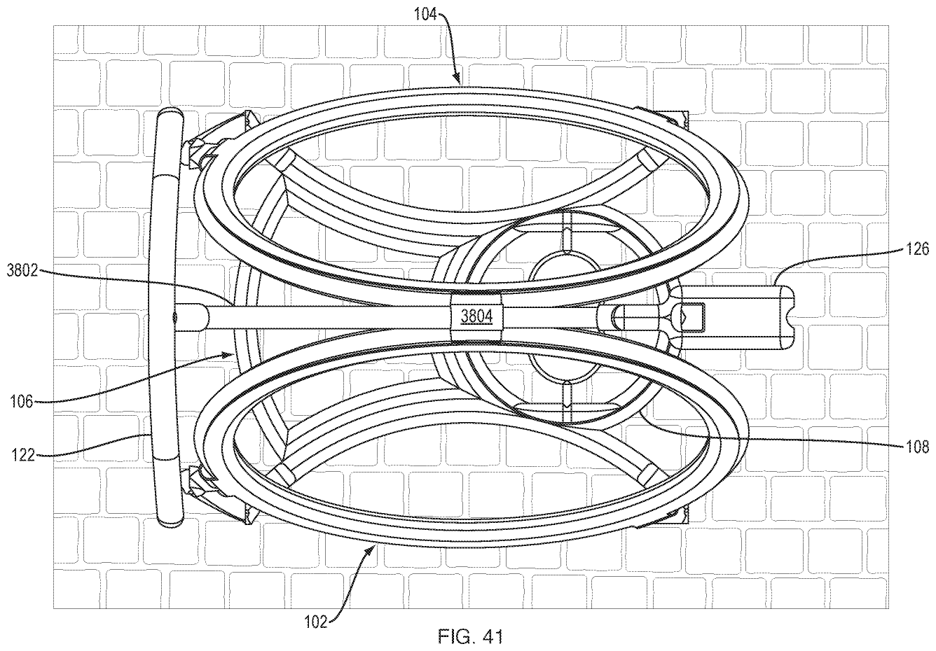

FIGS. 38-41 illustrate a modification of the configuration of FIGS. 32-37 to enable it to be ridden by a human user while also carrying a package on the midframe. To that end, a top bar 3802 is coupled at the intersection of the wheels at 3202 by means of a coupling 3804. The handlebar 122 is positioned at one end of the bar 3802 and the seat 126 is positioned at the other end of the bar. The unit can be controlled by the handgrips 208 and 2010 on the handlebar 122. FIG. 38 shows a perspective view of this configuration; FIG. 39 shows the side view; FIG. 40 shows an end view; and FIG. 41 shows a top view. As noted, this configuration allows a package to be carried as in FIG. 36. Torque sensors in the handlebar support 124 may also be used to receive direction and speed commands from the human. As in all other configurations, three axis accelerometers and three axis gyros enable the bicycle control system to keep the bike upright as shown. Also, as in all other configurations the unit may be operated as an autonomous robot without a human driver.

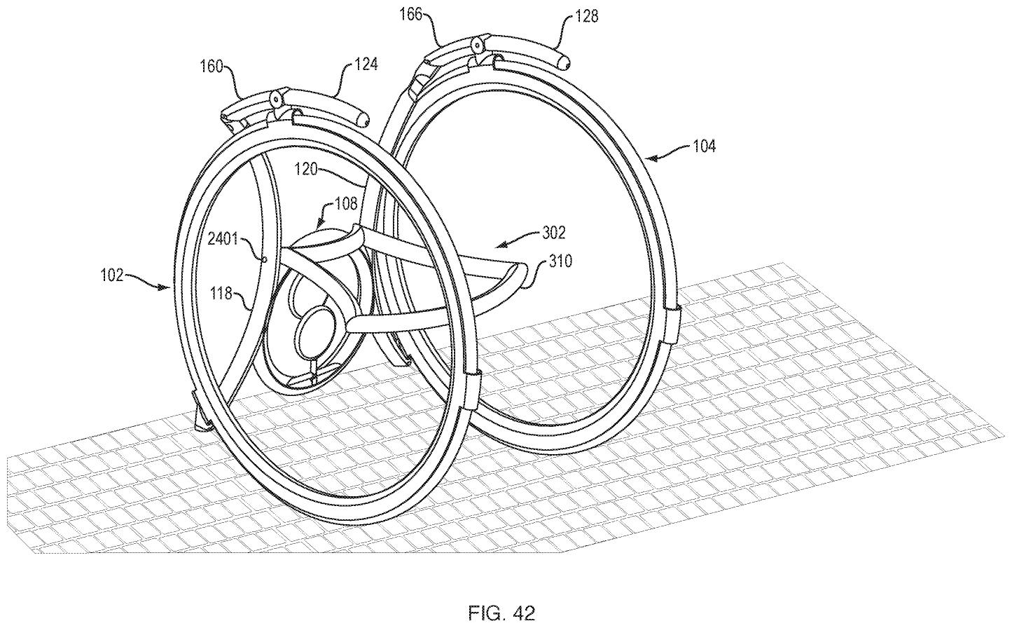

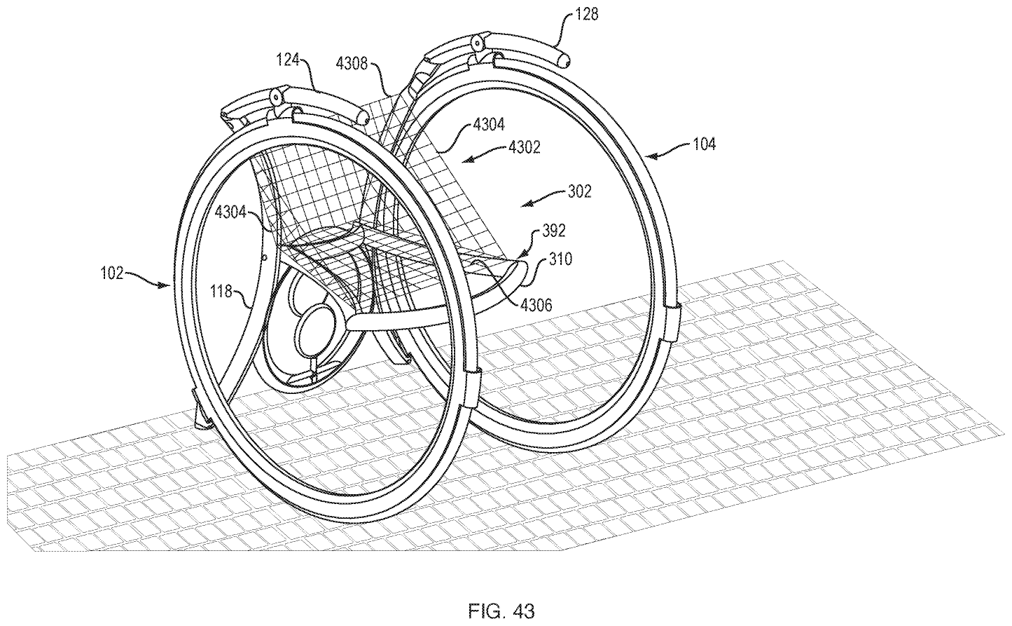

FIGS. 42-46 illustrate yet another configuration, a seated configuration. Here, the bicycle is configured as in the walker configuration of FIGS. 21-24 except that the midframe addition 302 is pivoted on pins 2401 all the way to a horizontal position. A user may sit on the bar 310 and control the seated bicycle using the handlebar and seat supports 124, 128 as control handles. As illustrated in FIG. 43, a web 4302 may be coupled to the frame tubes 118 and 120 and to the midframe addition 302 to increase the comfort of the user with a seat 4306 and a back 4308 and also to provide additional support to the midframe edition 302 through the sides 4304 of the web.

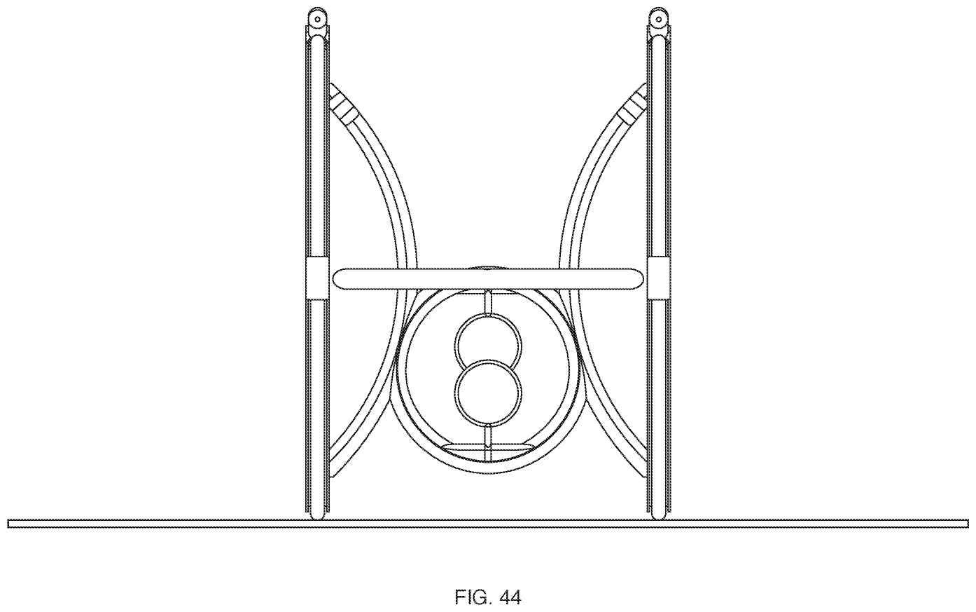

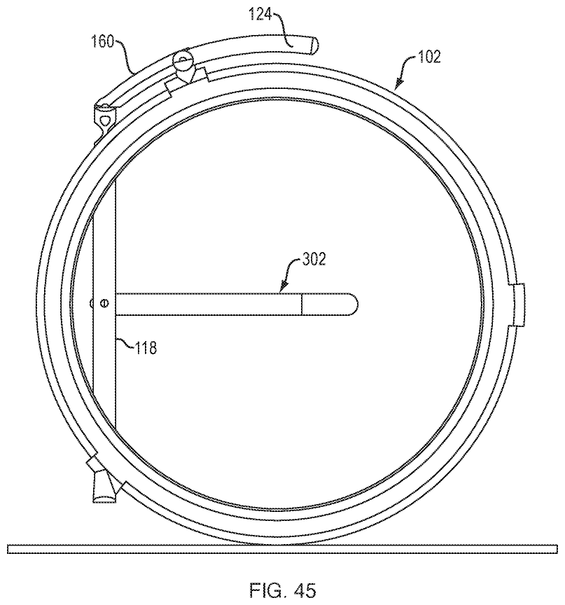

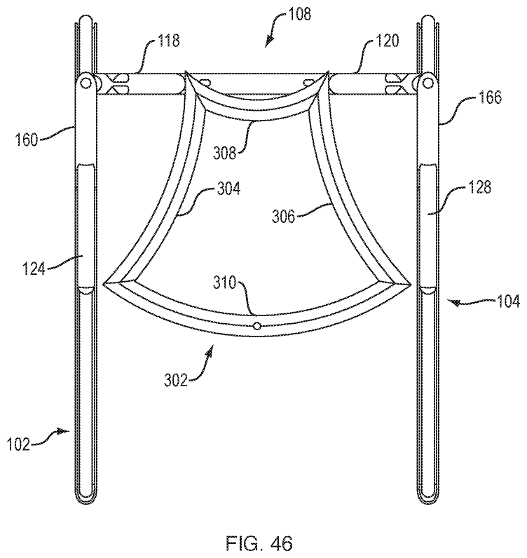

FIG. 44 shows an end view of this configuration without the web; FIG. 45 shows a side view of this configuration without the web; and the FIG. 46 shows a top view of this configuration without the web.

As with all other configurations, the multi-axis force/torque sensors may be used to detect direction and speed commands from the human user. Accelerometers and gyros may be used to maintain the unit in the stable upright position as illustrated, and the unit may be operated as an autonomous robot without a human driver.

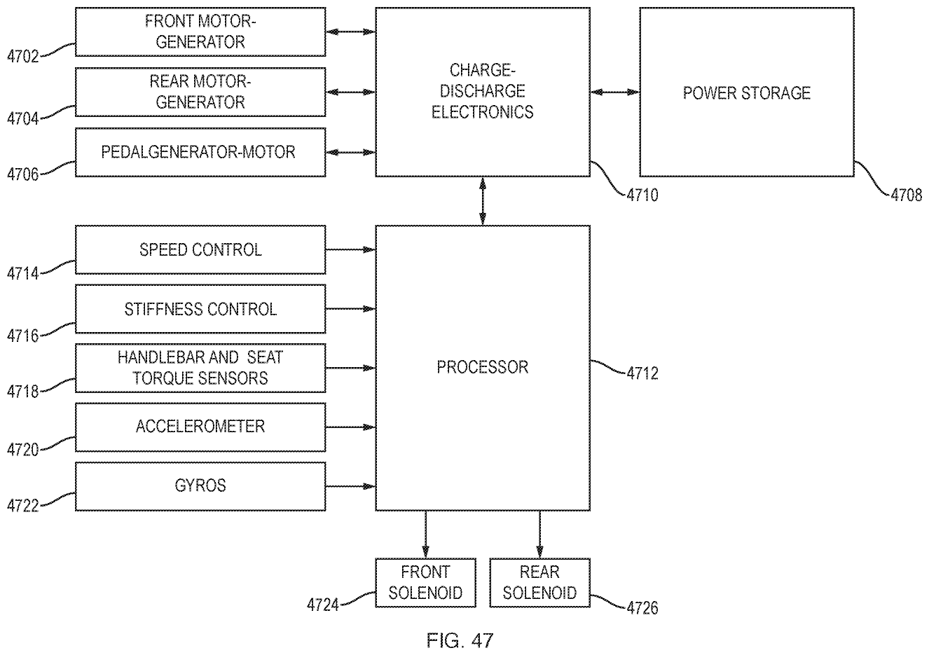

FIG. 47 illustrates the electronic and the power components of the bicycle. The front motor-generator 4702 corresponds to the stator 130, rotor 138 forming the front motor-generator. Rear motor-generator 4704 corresponds to the rear stator 142 and rotor 150. Pedal generator-motor 4706 corresponds to the generator-motor 108. These motor-generators charge the power storage 4708 and are powered from the power storage 4708 through power electronics 4710. As previously noted, the power storage may be in batteries, capacitors or a combination of the two. Charge-discharge of the storage and powering of the motor-generators is controlled by a processor 4712 through the power electronics 4710. The processor responds to internal software programming and to external inputs. Inputs include speed control 4714 which may be obtained from the right grip 210 of the handlebar 122. Stiffness control 4716 may, for example, be fed from the left grip 208. Multidirectional torque input may be obtained from torque sensors 4718 that may, for example, be mounted in the handlebar support 124 and seat support 128. Accelerometers 4720 and gyros 4722 mounted anywhere within the midframe provide inputs to the processor to enable the bicycle to stand in a stable upright position in each of the many configurations. The front and rear solenoids used to lock the swivel joints 162, 168 are controlled by the processor. Other inputs and outputs to and from the processor may also be provided from and to a controller such as an application in a smart phone. The components 4708, 4710, 4712, 4720 and 4722 may all be mounted within the base midframe 106 of FIGS. 1 and 2 and, optionally, in the midframe addition 302.

While example embodiments have been particularly shown and described, it will be understood by those skilled in the art that various changes in form and details may be made therein without departing from the scope of the embodiments encompassed by the appended claims.

1. An electric bicycle comprising:
a midframe;
a pedal driven generator supported by the midframe with pedals extending to opposite sides of the midframe;
front and rear wheels, each wheel comprising a rotating tire, each wheel mounted to the midframe with a swivel mount, the wheels configured to swivel from in-line positions to collapsed positions alongside the midframe on opposite sides of the midframe;
a handlebar mounted through a handlebar support to the front wheel;
a seat mounted through a seat support over the rear wheel;
a first wheel motor in a first wheel of the front and rear wheels, the first wheel motor comprising a stator fixed to the midframe and a rotor that drives the tire of the first wheel;
a current source charged by the pedal driven generator; and
electronics for controlling charging of the current source from the pedal driven generator and delivery of power to the wheel motor from the current source.

2. The bicycle as claimed in claim 1 further comprising a second wheel motor in a second wheel of the front and rear wheels, the second wheel motor comprising a stator fixed to the midframe and a rotor that drives the tire of the second wheel.

3. The bicycle as claimed in claim 1 wherein each swivel mount comprises a single axis joint that swivels about a tilted swivel axis.

4. The bicycle as claimed in claim 1 wherein each stator comprises opposed stator rings forming a wheel rim, and the rotor is positioned between the stator rings and supports the tire.

5. The bicycle as claimed in claim 4 wherein the center region of the wheel within the stator is open.

6. The bicycle as claimed in claim 1 wherein the pedal driven generator comprises a rotor ring to which the pedals are mounted and a stator ring fixed to the midframe.

7. The bicycle as claimed in claim 6 wherein the pedals pivot to close into an open center region of the generator.

8. The bicycle as claimed in claim 1 wherein the seat and handlebar are configured to be repositioned to enable a rider to pedal the bicycle as a unicycle when the wheels are in the collapsed position.

9. The bicycle as claimed in claim 8 configured to stand stationary as the pedals are driven in an exercise configuration.

10. The bicycle as claimed in claim 1 configurable to swivel the front and rear wheels to a same side of the midframe perpendicular to the midframe.

11. The bicycle as claimed in claim 10 configured as a walker, with the handlebar and seat removed, the handlebar support and seat support serving as handles.

12. The bicycle as claimed in claim 10 wherein a first portion of the midframe to which the front and rear wheels are mounted is upright and another portion of the midframe pivots from the first portion to serve as a seat.

13. The bicycle as claimed in claim 10 wherein the wheels are rotated to position the midframe close to and along the ground to support a load.

14. The bicycle as claimed in claim 13 wherein the wheels are swiveled further to meet away from the ground.

15. The bicycle as claimed in claim 1 wherein the handlebar support and the seat support are each mounted to swivel about a transverse axis.

16. The bicycle as claimed in claim 1 wherein the midframe comprises a curved front frame tube coupled at opposite ends to the stator of the front wheel, one end adjacent to the handlebar support, the swivel mount including a swivel joint in the front frame tube displaced from the handlebar support, and the midframe further comprises a curved rear frame tube coupled at opposite ends to the stator of the rear wheel, one end adjacent to the seat support, the swivel mount of the rear wheel comprising a swivel joint in the rear frame tube displaced from the seat support.

17. The bicycle as claimed in claim 1 wherein each wheel motor is also configured to operate as a generator and the pedal driven generator is operable as a motor.
